(19) United States
(12) Patent Application Publication
(10) Pub. No.: US 2009/0109362 A1
(43) Pub. Date: Apr. 30, 2009

(54) DISPLAY DEVICE

(75) Inventors: Yan-Jou Chen, Taipei County (TW); Yu-Chiung Yeh, Taipei County (TW); Yu-Ting Chen, Taipei County (TW); Hung-Jen Wang, Taipei County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HANNSTAR DISPLAY CORPORATION, Taipei County (TW)

(21) Appl. No.: 12/184,346

(22) Filed: Aug. 1, 2008

(30) Foreign Application Priority Data
Oct. 30, 2007 (TW) 096140872

(51) Int. Cl. G02F 1/136

(52) U.S. Cl. 349/40

(57) ABSTRACT

A display device is provided. The display device includes at least a substrate having a display region and a periphery region, a first ESD circuit and a pad disposed on the periphery region respectively. The pad has a first end near the display region and a second end near an edge of the substrate. A first connection line extended from the first end is electrically connected with a second connection line extended from the ESD circuit.

### FIELD OF THE INVENTION

The present invention relates to a display device, and more particularly to a display device having an electrostatic discharge (ESD) protection structure.

### BACKGROUND OF THE INVENTION

In the manufacturing process of liquid crystal display (LCD), the substrate has many conducting lines intersected to each other, are probably damaged due to the electrostatic discharge (ESD), which might result in the malfunction of the LCD panel.

Please refer to FIG. 1, which schematically shows a conventional ESD protection structure formed along with an LCD pixel array on an LCD substrate according to the U.S. Pat. No. 7,158,194 by Lo et al. As shown in FIG. 1, an LCD substrate 100 has thereon a display region 120 and a periphery region 130 disposed on the margin of the display region 120. The display region 120 includes a plurality of san lines 12 and a plurality of data lines 16 intersected to each other, so as to form a plurality of pixels 10. In order to alleviate or eliminate the ESD formed on the substrate 100, a first rake metal 14 having a plurality fingers 14a is disposed on the periphery region 130, and each of the fingers 14a is configured to be corresponding to each of the scan lines 12. Further, in order to effectively release the ESD from the scan lines 12 to the first rake metal 14, each of the fingers 14a of the rake metal 14 and an end point of each scan lines 12 corresponding to each finger 14a are shaped in sharp tips. Similarly, a second rake metal 18 having a plurality fingers 18a corresponding to each of the data lines 16 is disposed on the other side of the periphery region 130. Each of the fingers 18a of the rake metal 18 and an end point of each date line 16 corresponding to each finger 18a are shaped in sharp tips for effectively releasing the ESD from the date lines 16 to the second rake metal 18. With such arrangement of rake metals 14 and 18, the respective sharp tips of the rake metals can easily discharging the electrostatic charges on the LCD substrate 100 and thus the problem that may caused by the ESD can be effectively avoided.

Further, please refer to FIG. 2, which schematically shows a further conventional ESD protection structure according to the US Patent Application 2004/0218108 by Ko et al. As shown in FIG. 2, an ESD protection structure on a thin film transistor (TFT) array substrate 200 includes a gate ESD protection structure 201 and a data ESD protection structure 203, both of which are electrically connected to each other by a shorting bar 205. In addition to the inner ESD protection structure formed by the gate ESD protection structure 201, the data ESD protection structure 203 and the shorting bar 205, an outer ESD protection structure is disposed on the periphery region of the TFT substrate 200. The outer ESD protection structure includes a gate pad ESD protection structure 215 connected to a gate pad 209 and a data pad ESD protection structure 217 connected to a data pad 211 for discharging the electrostatic charges that might be formed through the gate pad 209 or date pad 211. With such arrangement of the inner and outer ESD protection structure, the electrostatic charges can be evenly distributed on the TFT substrate in order to avoid the electrostatic charges being extremely accumulated in a local area, which might result in the malfunction of the circuit on the local area.

Although the known ESD protection structures as shown in the respective FIGS. 1-2 can prevent the LCD substrate from the possible damage of the electrostatic charges, it is clear that those arrangement of ESD protection structures occupy a space of tens to hundreds of micrometers on the LCD substrate, which might result in the inconvenience of the circuit design on the LCD substrate. Further the additional space for the ESD protection structures is also unfavorable for utilization of LCD substrate.

### SUMMARY OF THE INVENTION

It is an aspect of the present invention to provide a display device having a novel electrostatic discharge (ESD) protection structure. The display device includes a substrate having thereon a display region and a periphery region, a first electrostatic discharge (ESD) protection structure disposed on the periphery region, and a pad disposed on the periphery region and having a first end adjacent to the display region and a second end adjacent to an edge of the substrate, wherein a first line is connected to the second end of the pad and a second line is connected to the first ESD protection, and the first line and the second line are electrically connected with each other.

Preferably, the first line and the second line are electrically connected with each other.

Preferably, the first ESD protection structure including a diode.

Preferably, the first ESD protection structure including a transistor having a drain electrode, a source electrode and a gate electrode.

Preferably, the drain electrode is electrically connected to the gate electrode.

Preferably, the source electrode is electrically connected to the gate electrode.

Preferably, the pad has a metal layer made of the same material as what the gate electrode is made of.

Preferably, the pad has a metal layer made of the same material as what the source electrode is made of.

Preferably, the display device further including a second ESD protection structure, wherein the second ESD protection structure is electrically connected to the first end.

Preferably, the first end is electrically connected to the second ESD protection structure through an integrated circuit (IC).

In accordance with the aspect of the present invention, a further display device having a novel electrostatic discharge (ESD) protection structure is provided. The liquid crystal display includes a substrate having thereon a display region and a periphery region, a first electrostatic discharge (ESD) protection structure disposed on the periphery region, and a pad disposed on the periphery region and having a first end adjacent to the display region and a second end adjacent to an edge of the substrate, wherein a first line is connected to the second and a second line is connected to the first ESD protection structure, and the first line and the second line respectively trace along edges of the substrate.

Preferably, the first line has an end being cut corresponding to an edge of the substrate.

Preferably, the second line has an end being cut corresponding to an edge of the substrate.

Preferably, the first ESD protection structure including a diode.

Preferably, the first ESD protection structure including a transistor having a drain electrode, a source electrode and a gate electrode.

Preferably, the drain electrode is electrically connected to the gate electrode.

Preferably, the source electrode is electrically connected to the gate electrode.

Preferably, the pad has a metal layer made of the same material as what the gate electrode is made of.

Preferably, the pad has a metal layer made of the same material as what the source electrode is made of.

Preferably, the display device further including a second ESD protection structure, wherein the second ESD protection structure is electrically connected to the first end.

Preferably, the first end is electrically connected to the second ESD protection structure through an integrated circuit (IC).

The foregoing and other features and advantages of the present invention will be more clearly understood through the following descriptions with reference to the drawings, wherein:

### BRIEF DESCRIPTION OF THE DRAWINGS

FIG. 1 is a diagram schematically showing a conventional ESD protection structure formed along with an LCD pixel array on an LCD substrate;

FIG. 2 is a diagram schematically showing a further conventional ESD protection structure;

FIG. 3 is a diagram schematically showing a substrate of a display device having an ESD protection structure according to a first embodiment of the present invention;

FIG. 4 is a diagram schematically showing a substrate of a display device having an ESD protection structure according to an alternative embodiment of FIG. 3;

FIG. 5 is a diagram schematically showing the deployment of the ESD protection structure according to the present invention formed on a substrate having a plurality of circuit arrays;

FIG. 6(A) and FIG. 6(B) are the diagrams respectively showing the equivalent circuit of the ESD protection structure according to the present invention; and

FIG. 7(A)-(C) are the diagrams respectively showing the deployment of the components of the ESD protection structure according to the present invention and a cross-sectional view thereof.

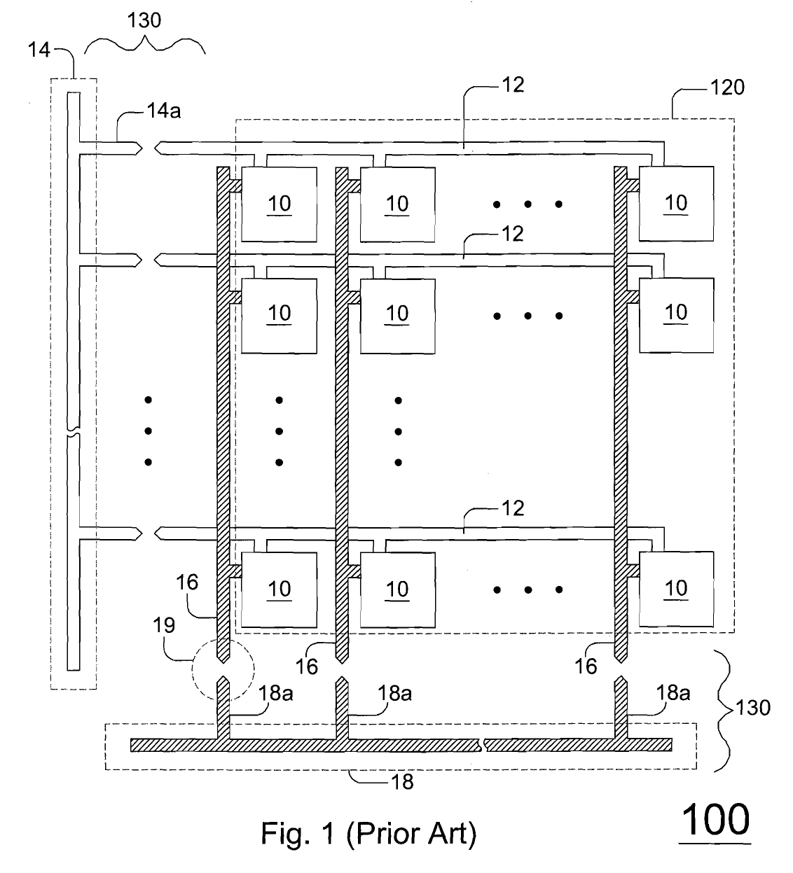

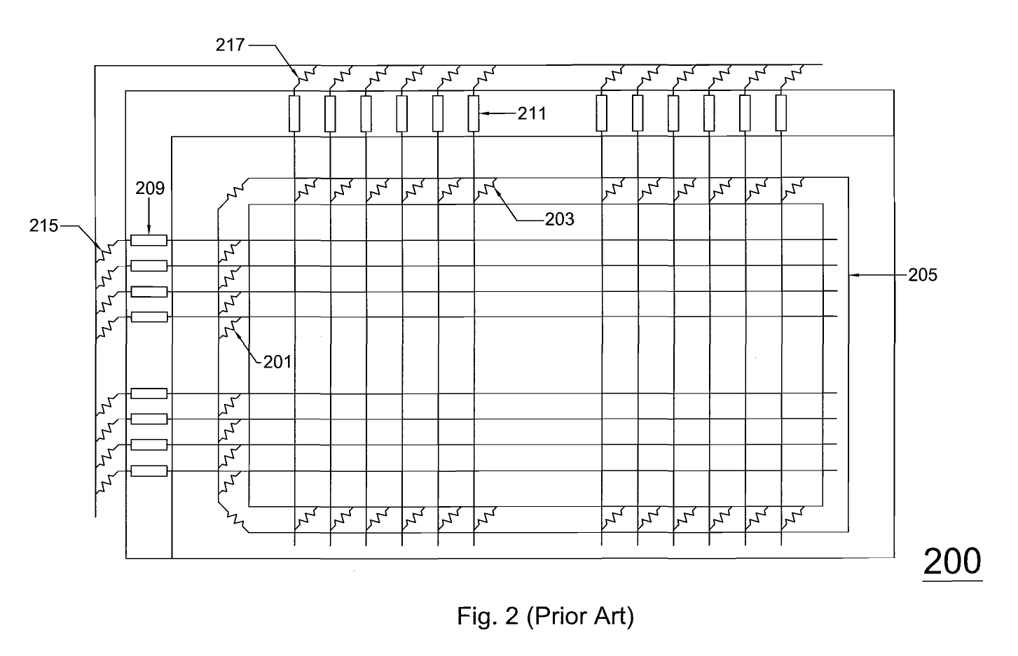

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

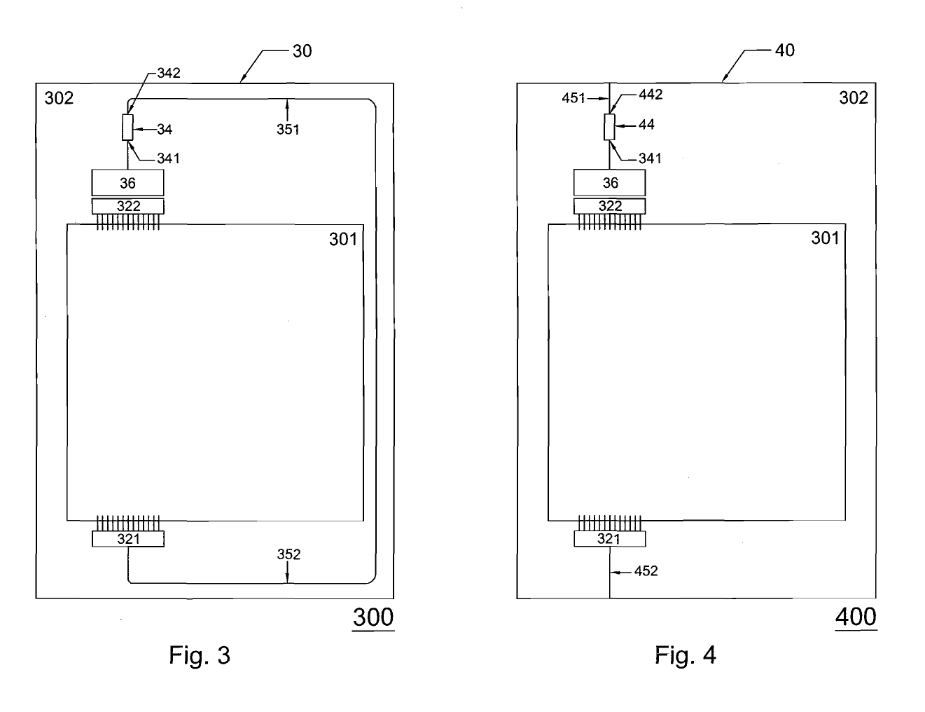

Please refer to FIG. 3, which schematically shows a substrate of a display device having an ESD protection structure according to a first embodiment of the present invention. As shown in FIG. 3, a display device 300 includes a substrate 30 having thereon a display region 301 and a periphery region 302. A first electrostatic discharge (ESD) protection structure 321 and a pad 34 are disposed on the opposite sides of the periphery region 302. The pad 34 has a first end 341 adjacent to the display region 301 and a second end 342 adjacent to an edge of the substrate 30, where a first line 351 is connected to the second end 342 of the pad 34 and a second line 352 is connected to the first ESD protection structure, and the first line and the second line are electrically connected with each other. Moreover, the first end 341 of the pad 34 is electrically connected to a second ESD protection structure 322, and preferably, the first end 341 of the pad 34 is electrically connected to a second ESD protection structure 322 through an integrated circuit (IC) 36, either Chip on Film (COF) or TCP (tape carrier package).

Please refer to FIG. 4, which schematically shows a substrate of a display device having an ESD protection structure according to an alternative embodiment of the present invention. In comparison with the display device 400 in FIG. 4 with that in FIG. 3, the display device 400 has almost the similar components as what the device 300 has. As shown in FIG. 4, the display device 400 includes a substrate 40 having thereon a display region 301 and a periphery region 302. A first electrostatic discharge (ESD) protection structure 321 and a pad 44 are disposed on the opposite sides of the periphery region 302. The pad 44 has a first end 341 adjacent to the display region 301 and a second end 442 adjacent to an edge of the substrate 40, and the first end 341 of the pad 44 is electrically connected to a second ESD protection structure 322 thorough an integrated circuit 36. Nevertheless, the only difference between the display device 400 and the display device 300 is a first line 451 is connected to the second end 442 of the pad 44 and a second line 452 is connected to the first ESD structure 321, and the first line 451 and the second line 452 respectively trace along the opposite edges of the substrate 40. Therefore, there exist no direct electrical interconnection between the first line 451 and the second line 452.

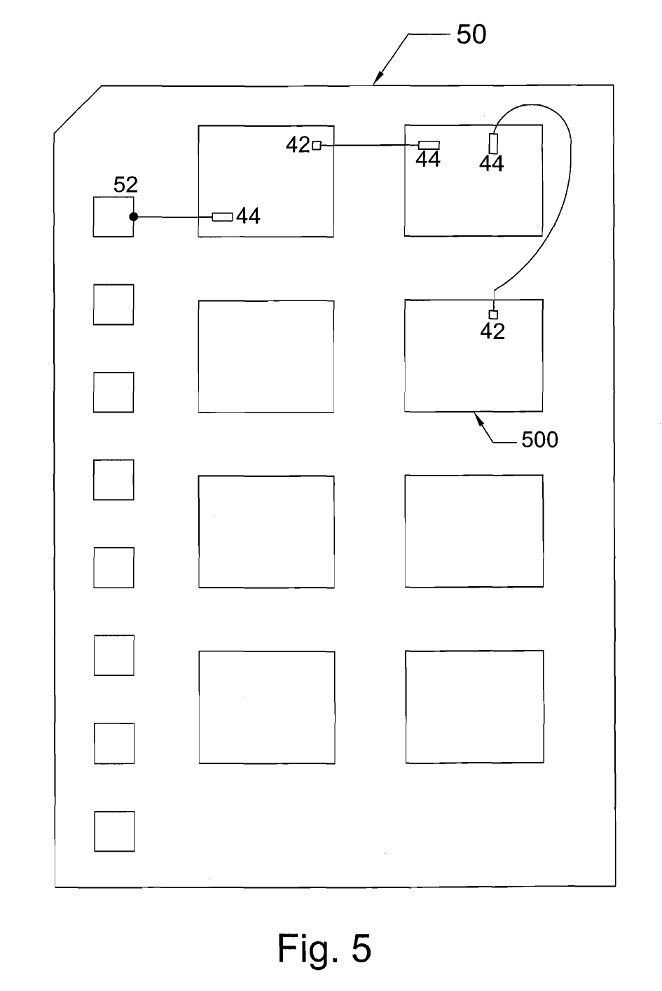

Please refer to FIG. 5, which schematically shows the deployment of the ESD protection structure according to the present invention formed on a substrate having a plurality of circuit arrays. As shown in FIG. 5, a processing substrate 50 having a plurality of display panel substrate 500 deployed thereon is provided. Each of the display panel substrate 500 includes at least one ESD protection structure 42 for discharging the electrostatic charges within the display panel substrate 500. Furthermore, a plurality of ESD protection structures 52 are also disposed on the periphery area of the processing substrate 50, so as to facilitate the discharge of the electrostatic charges within the processing substrate. During the process of the processing substrate, each pad 44 in one display panel substrate 500 is usually electrically connected to the ESD protection structure 42 in the adjacent display panel substrate or to the ESD protection structure 52 disposed on the periphery area of the processing substrate 50, in order to effectively prevent the circuit array within display panel substrate 500 from being damaged by the electrostatic discharge. Nevertheless, after the circuit array process is finished, each of the display panel substrate 500 should be cut by piece, and therefore, the line originally electrically connected from the pad in one panel substrate to the ESD protection structure in the adjacent panel substrate is cut corresponding to an edge of the display panel substrate 500.

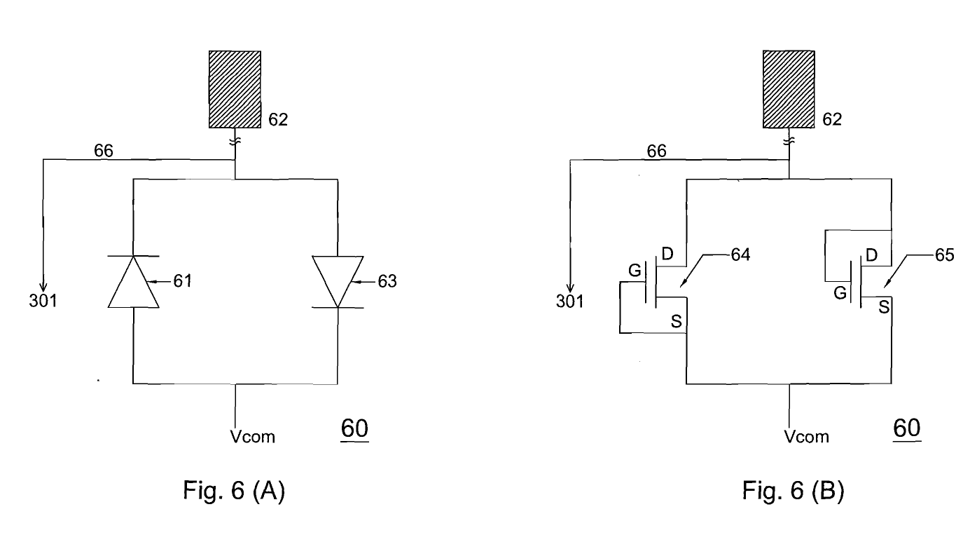

Please refer to FIG. 6(A) and FIG. 6(B), which respectively showing two equivalent circuits of the ESD protection structure according to the present invention. As shown in FIG. 6(A), the ESD protection structure 60 includes two diodes 61 and 63 electrically connected in parallel. Further, the ESD protection structure 60 has a first end electrically connected to a pad 62 of the display device, and a second end electrically connected to a common voltage (Vcom) of the display device. Moreover, the ESD protection structure 60 is electrically connected to the display region 301 of the display device through a connection 66, which might be one of the gate line and data line or the combination thereof. On the other side, the ESD protection structure 60 in the FIG. 6(B) is to replace the diodes 61 and 63 by two transistors 64 and 65 connected in parallel. The transistor 64 has a gate electrode G, a source electrode S and a drain electrode D, where the source electrode S of the transistor 64 is electrically connected to the gate electrode G the transistor 64. The transistor 65 also has a gate electrode G, a source electrode S and a drain electrode D, while it is the drain electrode D, instead of the source electrode S, of the transistor 65 being electrically connected to the gate electrode G the transistor 65. Except to the replacement of the two diodes, the connection arrangement of the ESD protection structure 60 in the FIG. 6(B) is similar to that in the FIG. 6(A). Further, in such a ESD protection structure 60 of FIG. 6(B), the pad has a metal layer made of the same material as what the gate, source or drain electrode is made of.

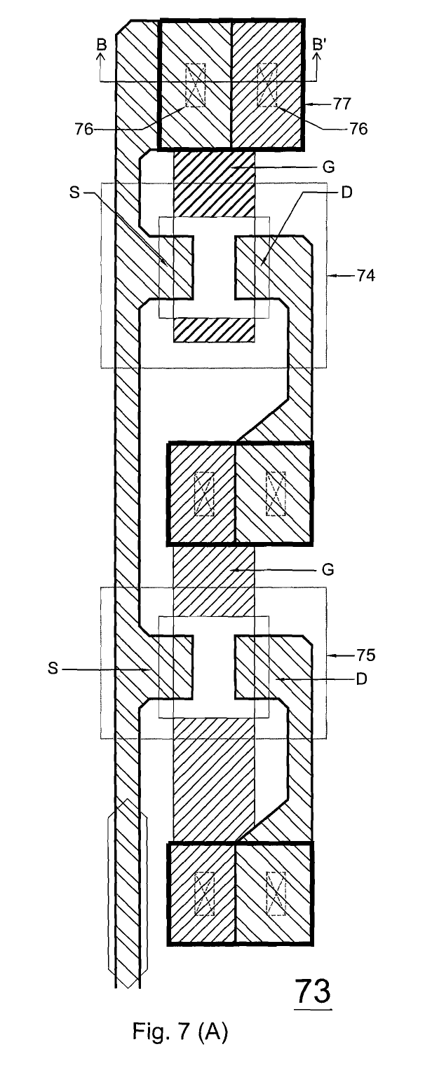

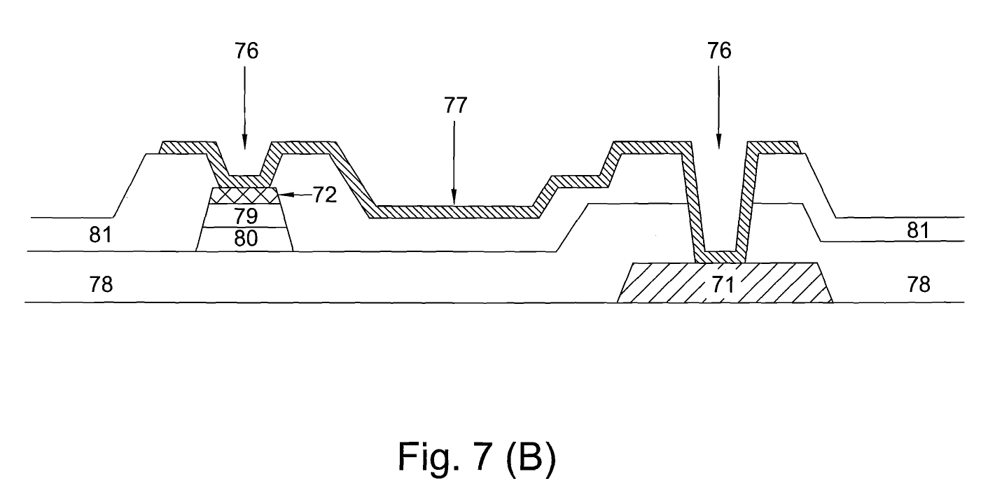

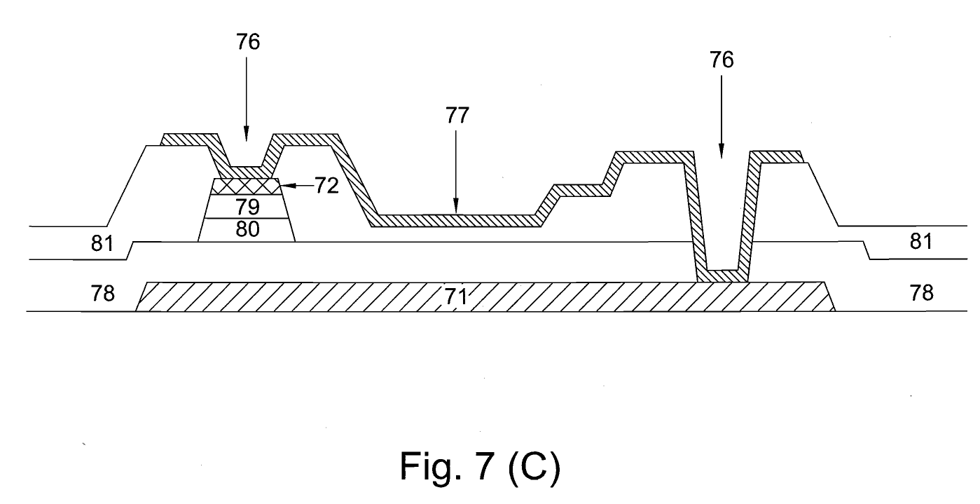

Pease refer to FIG. 7(A)-(C), which respectively shows the arrangement of the components of the ESD protection structure according to the present invention and a possible cross-sectional view thereof. As shown in FIG. 7(A), the ESD protection structure includes two transistors 74 and 75 (similar to the transistors shown in FIG. 6(B)), where the respective gate electrodes G are formed by a first metal layer, and the respective source electrodes S and drain electrodes D are formed by a second metal layer. The first metal layer and the second metal layer is electrically connected by a through hole 76 and a connection metal layer 77, so that the gate electrode G of the transistor 74 is electrically connected to the source electrode S of the transistor 74, while the gate electrode G of the transistor 75 is electrically connected to the drain electrode D of the transistor 75. Further, please refer to FIG. 7(B), which schematically shows the BB′ cross-sectional view of FIG. 7(A) according to one embodiment of the present invention. As shown in FIG. 7(B), the first metal layer 71 has an insulation layer 78, a passivation layer 81 and the through hole 76 formed thereon, and the second metal layer 72 has the passivation layer 81 and the through hole 76 formed thereon, both of which are electrically connected to each other through the connection metal layer 77. Also, a low resistor layer 79, a high resistor layer 80 and the insulation layer 78 are dispose beneath the second metal layer 72. On the other side, please refer to FIG. 7(C), which schematically shows the BB′ cross-sectional view of FIG. 7(A) according to a further embodiment of the present invention. As shown in FIG. 7(C), the only difference between FIG. 7(C) and FIG. 7(B) is the first metal layer 71 is extended to the beneath of the second metal layer 72, while the other portion of the two arrangements are similar.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A display device, comprising:
a substrate having a display region and a periphery region;
a first electrostatic discharge (ESD) protection structure disposed on the periphery region; and
a pad disposed on the periphery region and having a first end adjacent to the display region and a second end adjacent to an edge of the substrate,
wherein a first line is connected to the second end of the pad and a second line is connected to the first ESD protection structure

2. A display device according to claim 1, wherein the first line and the second line are electrically connected with each other.

3. A display device according to claim 1, wherein the first ESD protection structure comprising a diode.

4. A display device according to claim 1, wherein the first ESD protection structure comprising a transistor having a drain electrode, a source electrode and a gate electrode.

5. A display device according to claim 4, wherein the drain electrode is electrically connected to the gate electrode.

6. A display device according to claim 4, wherein the source electrode is electrically connected to the gate electrode.

7. A display device according to claim 4, wherein the pad has a metal layer made of the same material as what the gate electrode is made of.

8. A display device according to claim 4, wherein the pad has a metal layer made of the same material as what the source electrode is made of.

9. A display device according to claim 1, further comprising a second ESD protection structure, wherein the second ESD protection structure is electrically connected to the first end.

10. A display device according to claim 9, wherein the first end is electrically connected to the second ESD protection structure through an integrated circuit (IC).

11. A display device, comprising:
a substrate having a display region and a periphery region;
a first electrostatic discharge (ESD) protection structure disposed on the periphery region; and
a pad disposed on the periphery region and having a first end adjacent to the display region and a second end adjacent to an edge of the substrate,
wherein a first line is connected to the second and a second line is connected to the first ESD protection structure, and the first line and the second line respectively trace along edges of the substrate.

12. A display device according to claim 11, wherein the first line has an end being cut corresponding to an edge of the substrate.

13. A display device according to claim 11, wherein the second line has an end being cut corresponding to an edge of the substrate.

14. A display device according to claim 11, wherein the first ESD protection structure comprising a diode.

15. A display device according to claim 11, wherein the first ESD protection structure comprising a transistor having a drain electrode, a source electrode and a gate electrode.

16. A display device according to claim 15, wherein the drain electrode is electrically connected to the gate electrode.

17. A display device according to claim 15, wherein the source electrode is electrically connected to the gate electrode.

18. A display device according to claim 15, wherein the pad has a metal layer made of the same material as what the gate electrode is made of.

19. A display device according to claim 15, wherein the pad has a metal layer made of the same material as what the source electrode is made of.

20. A display device according to claim 11, further comprising a second ESD protection structure, wherein the second ESD protection structure is electrically connected to the first end.

21. A display device according to claim 20, wherein the first end is electrically connected to the second ESD protection structure through an integrated circuit (IC).
